(19) United States
(12) Patent Application Publication
(10) Pub. No.: US 2022/0291178 A1
(43) Pub. Date: Sep. 15, 2022

(54) AUTOSAMPLER

(71) Applicant: SHIMADZU CORPORATION, Kyoto (JP)

(72) Inventors: Hiroyuki MINATO, Kyoto (JP); Takashi INOUE, Kyoto (JP)

(21) Appl. No.: 17/635,448

(22) PCT Filed: Mar. 23, 2020
(86) PCT No.: PCT/JP2020/012753

§ 371 Date: Feb. 15, 2022

(30) Foreign Application Priority Data
Aug. 23, 2019 (JP) 2019-153209

(51) Int. Cl. G01N 30/24; G01N 35/10

(52) U.S. Cl. CPC G01N 30/24; G01N 35/10

(57) ABSTRACT

A needle driver moves a sampling needle. A display controller displays a layout input portion for receiving input of layout information in regard to an additional sample container in a display unit. A position information acquirer acquires position information representing positions of a predetermined count of containing portions in an additional sample container based on teaching work. A storage stores the input layout information and the acquired position information. A designation information acquirer acquires designation information designating a containing portion. A movement controller controls the needle driver based on the stored layout information, the stored position information and the acquired designation information such that the sampling needle is moved to the containing portion designated by the designation information.

### TECHNICAL FIELD

The present invention relates to an autosampler.

### BACKGROUND ART

In a liquid chromatograph, an autosampler is used to inject a sample into a separation column (see Patent Document 1). In the autosampler described in Patent Document 1, a sample rack is set. In the sample rack, a plurality of vials containing samples are placed. A sampling needle moving mechanism moves a sampling needle in a horizontal direction and a vertical direction. A sample in a vial is collected by the sampling needle and injected into an injection port.

[Patent Document 1] JP 2016-125908 A

### SUMMARY OF INVENTION

### Technical Problem

For example, a sample plate having a plurality of vial holes is used as a sample container used in a liquid chromatograph. Vials are respectively inserted into the plurality of vial holes of the sample plate. A plurality of types of sample plates having different counts and different diameters of vial holes are prepared to correspond to vial types. In a control program for automatically controlling the autosampler, fixed information corresponding to the plurality of types of sample plates is incorporated. The fixed information includes a row vial-hole count and a column vial-hole count of a sample plate corresponding to a vial type. Further, the position information representing the accurate positions of vials inserted into a predetermined count of vial holes in each sample plate is acquired in advance based on teaching work.

With such an autosampler, when a user selects a vial type, the control program identifies a row vial-hole count and a column vial-hole count in a sample plate corresponding to a vial type and moves the sampling needle to a designated vial hole in the sample plate based on the position information acquired based on the teaching work. Thus, a sample in a vial is collected in accordance with a type of the sample plate.

However, with the above-mentioned autosampler, a new type of a sample plate cannot be used immediately. Correction and addition in regard to the control program are necessary for use of a new type of a sample plate.

An object of the present invention is to provide an autosampler that can collect a sample from any type of a sample container without a change of configuration.

### Solution to Problem

An autosampler according to one aspect of the present invention that collects a sample from each containing portion of a sample container, includes a holder that can selectively hold a default sample container and an additional sample container different from the default sample container, a sampling needle, a needle driver that moves the sampling needle, a layout input portion that receives input of layout information including a layout and a count of a plurality of containing portions in the additional sample container, a position information acquirer that acquires position information representing positions of a predetermined count of containing portions in an additional container held by the holder based on teaching work, a storage that stores layout information input to the layout input portion and position information acquired by the position information acquirer, a designation information acquirer that acquires designation information designating a containing portion to which the sampling needle is to be moved out of the plurality of containing portions in an additional sample container held by the holder, and a movement controller the controls the needle driver based on the stored layout information, the stored position information and the acquired designation information such that the sampling needle is moved to a containing portion designated by the designation information.

### Advantageous Effects of Invention

With the present invention, it is possible to collect a sample from any type of a sample container without changing the configuration.

### [BRIEF DESCRIPTION OF THE DRAWINGS]

FIG. 1 is a schematic diagram showing the configuration of an analysis system including an autosampler according to one embodiment.

FIG. 2 is a diagram showing one example of an additional plate having a standard layout.

FIG. 3 is a diagram showing one example of an additional plate having a staggered layout.

FIG. 4 is a diagram showing another example of an additional plate having a staggered layout.

FIG. 5 is a diagram showing one example of a plate type selection screen displayed in a display unit.

FIG. 6 is a diagram showing one example of a standard layout information input screen displayed in the display unit.

FIG. 7 is a diagram showing one example of a staggered layout information input screen displayed in the display unit.

FIG. 8 is a block diagram showing the functional configuration of a calculation control device of FIG. 1.

FIG. 9 is a flowchart showing one example of work of an autosampler.

FIG. 10 is a flowchart showing one example of work of the autosampler.

### DESCRIPTION OF EMBODIMENTS

An autosampler according to embodiments will be described below in detail with reference to the drawings.

(1) Configuration of Analysis System Including Autosampler

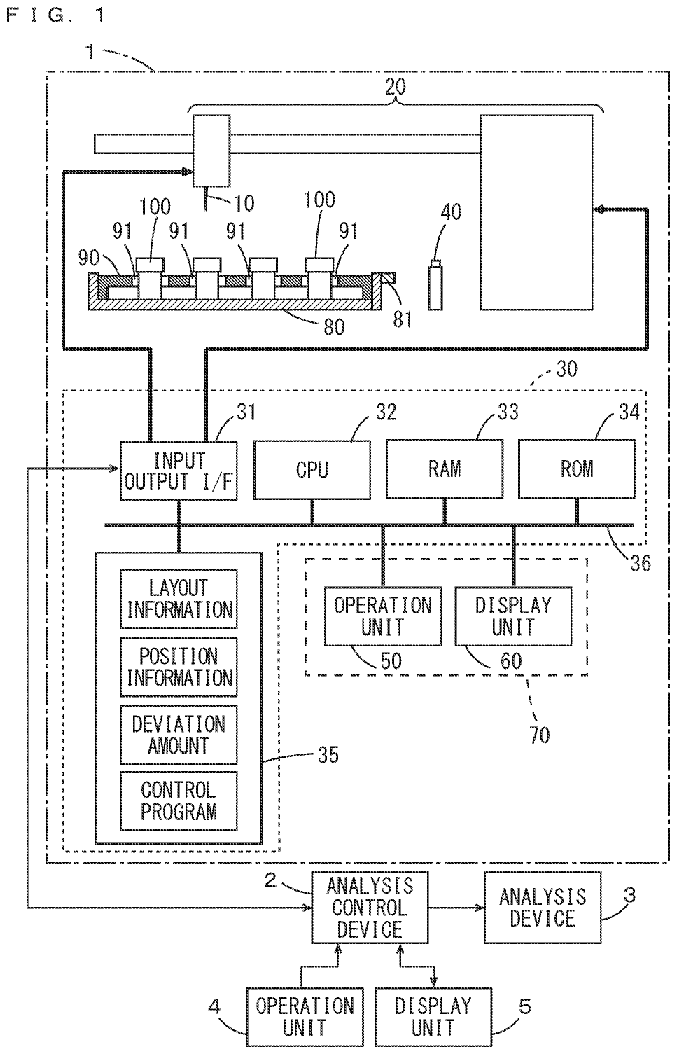

FIG. 1 is a diagram showing the configuration of an analysis system including an autosampler according to one embodiment. The analysis system shown in FIG. 1 includes the autosampler 1, an analysis control device 2, an analysis device 3, an operation unit 4 and a display unit 5. The autosampler 1 includes a sampling needle 10, a needle driving device 20, a calculation control device 30, an injection port 40, an operation unit 50 and a display unit 60.

Further, one or a plurality of sample racks 80 are attached to the autosampler 1. A rack ID switch 81 for setting a rack ID (identifier) is provided at each sample rack 80. A rack ID is used for identification of a sample rack 80. For example, in a case in which a plurality of sample racks 80 are attached to the autosampler 1, the rack ID switches 81 of the sample racks 80 are respectively set to different rack IDs. In the example of FIG. 1, one sample rack 80 is provided. A sample plate 90 is fitted to each sample rack 80. A plurality of vial holes 91 are formed in the sample plate 90. A vial 100 containing a sample is inserted into each vial hole 91.

Hereinafter, a defined type of a sample plate 90 in the autosampler 1 is referred to as a default plate, and a different type of a new sample plate 90 which is different from the default plate is referred to as an additional plate.

The needle driving device 20 moves the sampling needle 10 in a vertical direction and a horizontal direction. Specifically, the sampling needle 10 is moved to a position above a designated vial 100 and then lowered. Thus, the tip of the sampling needle 10 is inserted into the vial 100. The needle driving device 20 incorporates an encoder. The position of the sampling needle 10 can be acquired based on an output signal of the encoder. Further, the needle driving device 20 causes a sample loop (not shown) to suck a sample through the sampling needle 10 and causes the sample loop to discharge the sample held by the sample loop through the sampling needle 10.

After sucking the sample in the vial 100, the sampling needle 10 is lifted to be moved to a position above the injection port 40. The sampling needle 10 is lowered to discharge the sample to the injection port 40. The sample discharged to the injection port 40 is introduced into the analysis device 3.

The calculation control device 30 includes an input output I/F (interface) 31, a CPU (Central Processing Unit) 32, a RAM (Random Access Memory) 33, a ROM (Read Only

Memory) and a storage device 35. The input output I/F 31, the CPU 32, the RAM 33, the ROM 34 and the storage device 35 are connected to a bus 36. The storage device 35 includes a hard disc, an optical disc, a magnetic disc, a semiconductor memory, a memory card or the like and stores a control program. The RAM 33 is used as a work area for the CPU 32. A system program is stored in the ROM 34. The CPU 32 executes the control program stored in the storage device 35 on the RAM 33, so that the autosampler 1 works as described below.

The operation unit 50 and the display unit 60 are connected to the bus 36. The operation unit 50 is used for inputting various values and the like and various operations. The display unit 60 displays various information and images. In the present embodiment, the operation unit 50 and the display unit 60 are constituted by a touch panel display 70. In this case, the operation unit 50 is displayed in the display unit 60 as an image. A user can perform a selecting operation, a designating operation, etc. by touching a predetermined portion in an image displayed in the display unit 60. Further, the user can input numerical values, characters and the like by touching ten keys or a keyboard displayed in the display unit 60.

The operation unit 50 and the display unit 60 may be provided separately. The operation unit 50 includes a keyboard, a pointing device, etc. The display unit 60 includes a liquid crystal display, an organic electroluminance display or the like.

The analysis control device 2 includes an input output I/F, a CPU, a RAM, a ROM and a storage device, controls the work of the analysis device 3 and provides an instruction to the autosampler 1. In the present embodiment, the analysis device 3 is a liquid chromatograph. The analysis device 3 is not limited to a liquid chromatograph but may be another analysis device such as a supercritical chromatograph. The operation unit 4 is used for inputting values and so on relating to the analysis device 3 and various operations. The display unit 5 is used to display a state of the analysis device 3, etc.

(2) Examples of Additional Plate

Hereinafter, two directions that are orthogonal to each other in a horizontal plate in the sample plate 90 are referred to as an X direction and a Y direction. The arrangement of a plurality of vial holes 91 in the X direction is referred to as a row, and the arrangement of a plurality of vials holes 91 in the Y direction is referred to as a column. The count of vial holes 91 in each row is abbreviated as a row hole count, and the count of vial holes 91 in each column is abbreviated as a column hole count. Different numbers are provided to the plurality of vial holes 91 of the sample plate 90. Additional plates include an additional plate having a standard layout and an additional plate having a staggered layout.

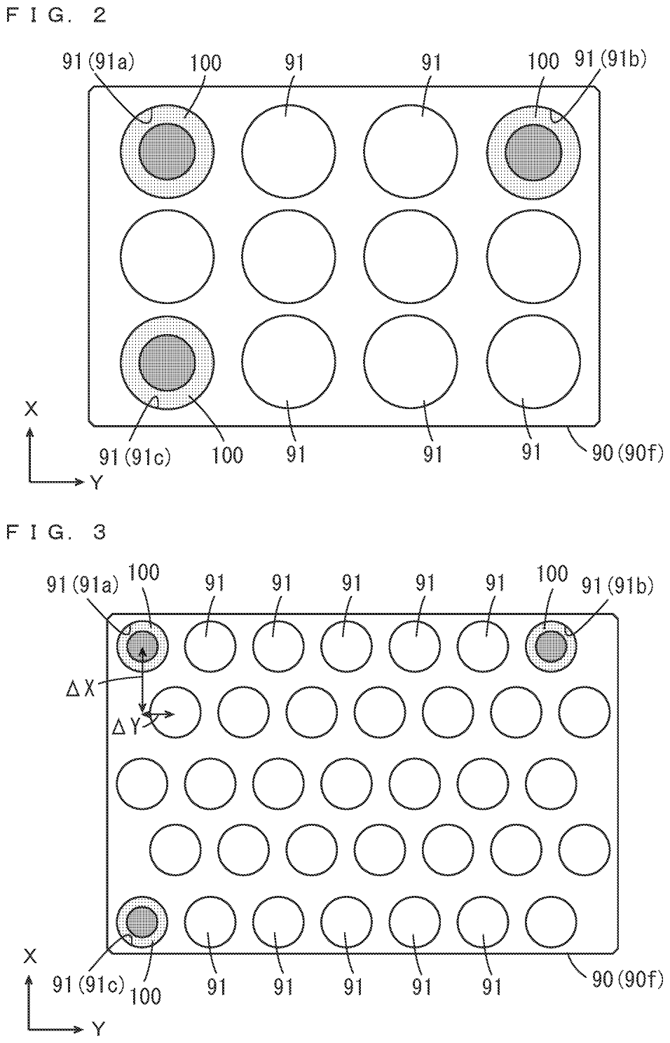

FIG. 2 is a diagram showing one example of an additional plate having a standard layout. In the standard layout, vial holes 91 in each row are arranged linearly in the X direction, and vial holes 91 of each column are arranged linearly in the Y direction. In the additional plate 90f of FIG. 2, the row hole count is 3, and the column hole count is 4. In FIG. 2, vials 100 are inserted into three vial holes 91a, 91b, 91c out of vial holes 91 in the four corners of the additional plate 90f.

FIG. 3 is a diagram showing one example of an additional plate having a staggered layout. In the staggered layout, in two adjacent columns, vial holes 91 corresponding to each other deviates from each other in the Y direction by a Y deviation amount ΔY. Further, in two adjacent columns, vial holes 91 corresponding to each other deviate from each other in the X direction by an X deviation amount ΔX. In the additional plate 90f of FIG. 3, the row hole count is 5, and the column hole count is 7. Also in the example of FIG. 3, vials 100 are respectively inserted into three vial holes 91a, 91b, 91c out of vial holes 91 in the four corners of the additional plate 90f.

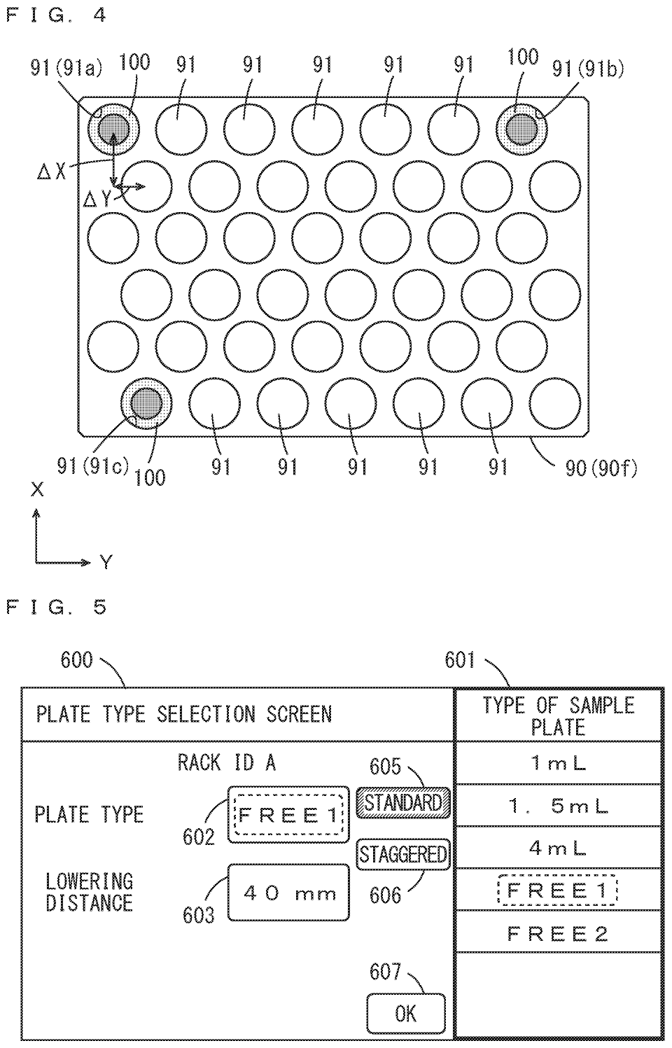

FIG. 4 is a diagram showing another example of an additional plate having a staggered layout. In the additional plate 90f of FIG. 4, the row hole count is 6, and the column hole count is 7. Also in the example of FIG. 4, vials 100 are respectively inserted into three vial holes 91a, 91b, 91c out of vial holes 91 in the four corners of the additional plate 90f.

(3) Examples of Display in Display Unit 60

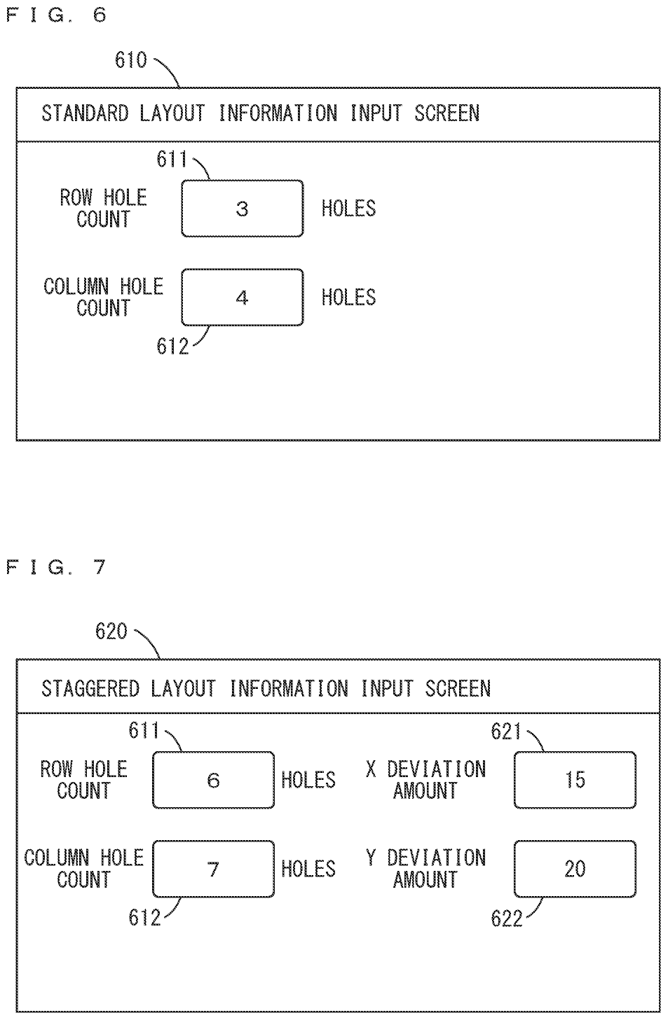

FIG. 5 is a diagram showing one example of a plate type selection screen displayed in the display unit 60. FIG. 6 is a diagram showing one example of a standard layout information input screen displayed in the display unit 60. FIG. 7 is a diagram showing one example of a staggered layout information input screen displayed in the display unit 60.

The plate type selection screen 600 of FIG. 5 includes a type selection region 601 for selecting a type of a sample plate 90, a plate type display field 602 for displaying a type of a selected sample plate 90 and a lowering distance setting field 603 for setting a lowering distance of the sampling needle 10. Further, the plate type selection screen 600 includes a standard layout selector 605 for selecting a standard layout, a staggered layout selector 606 for selecting a staggered layout and an OK button 607. In the type selection region 601, “1 mL” indicates a default plate for 1 mL vials, “1.5 mL” indicates a default plate for 1.5 mL vials and “4 mL” indicates a default plate for 4 mL vials. Further, “FREE1” and “FREE2” indicate any additional plate.

In the example of FIG. 5, an additional plate “FREE1” is selected in the type selection region 601, and “FREE1” is displayed in the plate type display field 602. Further, the standard layout selector 605 is selected.

When the OK button 607 is operated with the standard layout selector 605 in the plate type selection screen 600 of FIG. 5 selected, the standard layout information input screen 610 of FIG. 6 is displayed in the display unit 60. The standard layout information input screen 610 includes a layout input field 611 for inputting a row hole count, and a layout input field 612 for inputting a column hole count. The user inputs a row hole count of an additional plate 90f in the layout input field 611 and inputs a column hole count of the additional plate 90f in the layout input field 612 by using the operation unit 50. For example, in a case in which the additional plate 90f of FIG. 2 is fitted to a sample rack 80, the user inputs “3” in the layout input field 611 and inputs “4” in the layout input field 612.

When the OK button 607 is operated with the staggered layout selector 606 in the plate type selection screen 600 of FIG. 5 selected, the staggered layout information input screen 620 of FIG. 7 is displayed in the display unit 60. The staggered layout information input screen 620 includes a deviation amount input field 621 for input of an X deviation amount and a deviation amount input field 622 for input of a Y deviation amount in addition to the layout input field 611 and the layout input field 612. The user inputs an X deviation amount ΔX and a Y deviation amount ΔY in the additional plate 90f having the staggered layout in the deviation amount input field 621 and the deviation amount input field 622 using the operation unit 50. For example, in a case in which the additional plate 90f of FIG. 3 is fitted to a sample rack 80, the user inputs “6” in the layout input field 611, inputs “7” in the layout input field 612 and inputs a value of an X deviation amount ΔX and a value of a Y deviation amount ΔY in the deviation amount input fields 621, 622.

(4) Functional Configuration of Calculation Control Device 30

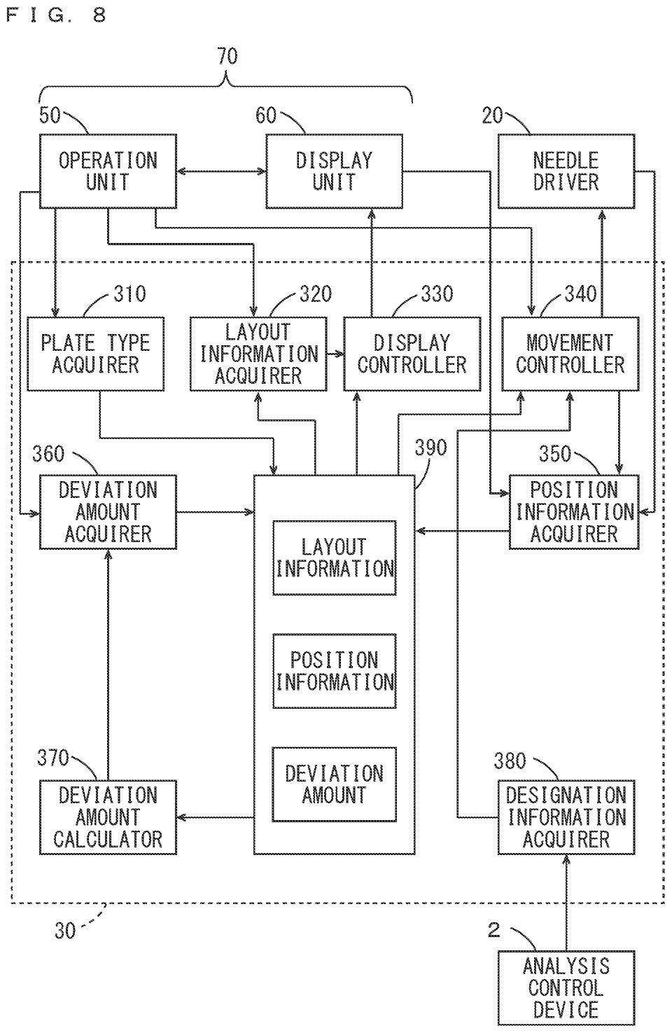

FIG. 8 is a block diagram showing the functional configuration of the calculation control device 30 of FIG. 1. As shown in FIG. 8, the calculation control device 30 includes a plate type acquirer 310, a layout information acquirer 320, a display controller 330, a movement controller 340, a position information acquirer 350, a deviation amount acquirer 360, a deviation amount calculator 370, a designation information acquirer 380 and a storage 390. The functions of the above-mentioned constituent elements (310 to 390) are implemented by execution of the control program which is a computer program stored in a storage medium (recording medium) such as the storage device 35 by the CPU 32 of FIG. 1. Part or all of the constituent elements of the calculation control device 30 may be implemented by hardware such as an electronic circuit.

The plate type acquirer 310 acquires a type of a sample plate 90 that is selected in the type selection region 601 of the plate type selection screen 600 of FIG. 5 with use of the operation unit 50. The layout information acquirer 320 acquires a row hole count and a column hole count that are input to the layout input fields 611, 612 in the standard layout information input screen 610 of FIG. 6 or the staggered layout information input screen 620 of FIG. 7 with use of the operation unit 50 as layout information. The layout information acquired by the layout information acquirer 320 is stored in the storage 390.

The display controller 330 controls the work of the display unit 60. Specifically, the display controller 330 displays the plate type selection screen 600 (FIG. 5), the standard layout information input screen 610 (FIG. 6) or the staggered layout information input screen 620 (FIG. 7) in the display unit 60. The movement controller 340 controls the needle driving device 20.

The position information acquirer 350 acquires a position of the sampling needle 10 being in a specific vial hole 91 as position information based on an output signal of the encoder of the needle driving device 20. The position information is represented by an X coordinate in the X direction, a Y coordinate in the Y direction and a Z coordinate in the vertical direction. The position information acquired by the position information acquirer 350 is stored in the storage 390.

The deviation amount acquirer 360 acquires an X deviation amount and a Y deviation amount that are input to the deviation amount input fields 621, 622 of the staggered layout information input screen 620 of FIG. 7 with use of the operation unit 50. Further, the deviation amount acquirer 360 acquires an X deviation amount and a Y deviation amount calculated by the deviation amount calculator 370, described below. The X deviation amount and the Y deviation amount acquired by the deviation amount acquirer 360 are stored in the storage 390.

The deviation amount calculator 370 calculates an X deviation amount and a Y deviation amount based on the layout information and the position information stored in the storage 390. For example, the XYZ coordinates of the centers of the vial holes 91a, 91b, 91c in the three corners of the additional plate 90f of FIG. 3 are stored as the position information. In this case, a X deviation amount ΔX can be calculated based on a row hole count of the layout information and the position information of the vial holes 91a, 91c. Further, the XYZ coordinates of the centers of the vial holes 91a, 91b, 91c in the three corners of the additional plate 90f of FIG. 4 are similarly stored as the layout information. In this case, an X deviation amount ΔX and a Y deviation amount ΔY can be calculated based on the row hole count of the layout information and the position information of the vial holes 91a, 91c.

During an analysis, the analysis control device 2 supplies designation information that designates a vial hole 91 into which a vial 100 containing a sample to be analyzed is inserted out of a plurality of vial holes 91 of a sample plate 90 to the calculation control device 30. The designation information acquirer 380 acquires the designation information supplied from the analysis control device 2. The movement controller 340 moves the sampling needle 10 to the vial hole 91 designated by the designation information acquired by the designation information acquirer 380.

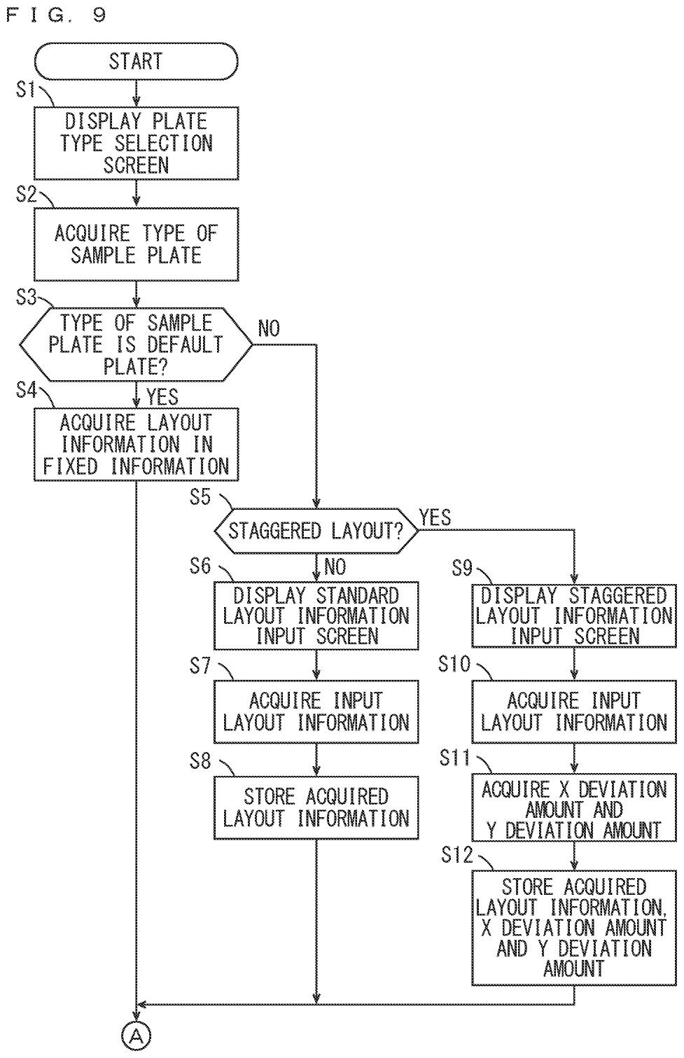

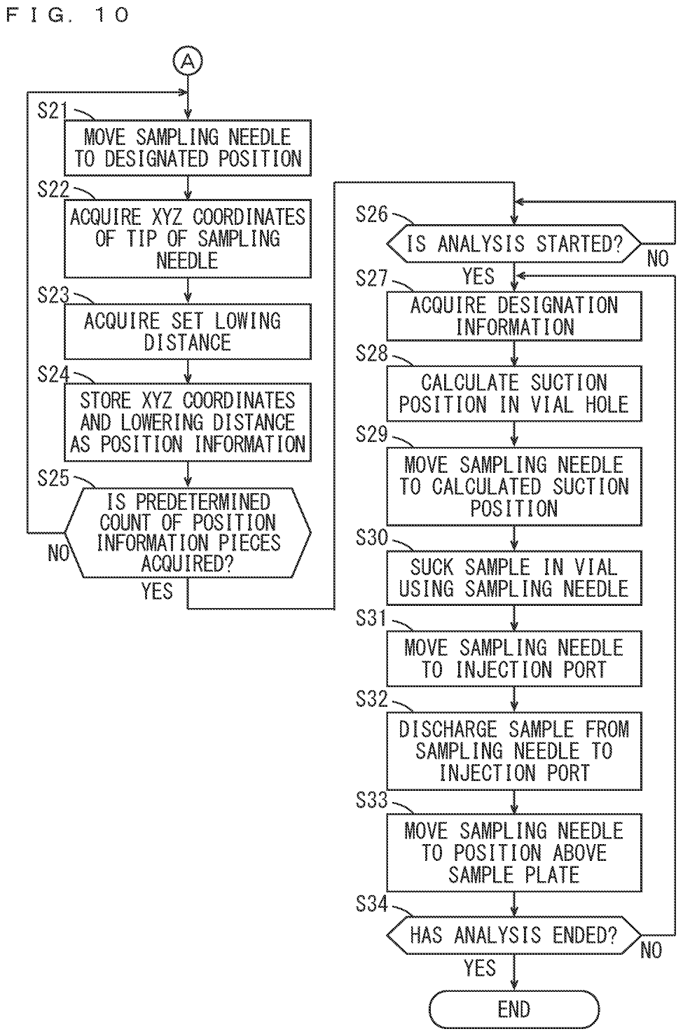

(5) Work of Autosampler 1 FIGS. 9 and 10 are flowcharts showing one example of the work of the autosampler 1. The autosampler 1 works when the CPU 32 of FIG. 1 executes the control program stored in the storage device 35 on the RAM 33.

The user sets a rack ID of a sample rack 80 using the rack ID switch 81. In the present example, “A” is set as a rack ID of the sample rack 80. The display controller 330 displays the plate type selection screen 600 of FIG. 5 in the display unit (step S1). In the plate type selection screen 600, “A” is displayed as the rack ID. Further, in the plate type selection screen 600, the type selection region 601 is displayed. The user selects a type of a sample plate 90 from the type selection region 601 using the operation unit 50.

The plate type acquirer 310 acquires the type of the sample plate 90 selected in the type selection region 601 of the plate type selection screen 600 of FIG. 5 with use of the operation unit (step S2). Next, the plate type acquirer 310 determines whether the acquired type of the sample plate 90 is the default plate (step S3). In a case in which the type of the sample plate 90 is the default plate, the layout information acquirer 320 acquires the layout information including a row hole count and a column hole count from the fixed information in the control program (step S4), and the process proceeds to the step S21.

In a case in which the type of the sample plate 90 is an additional plate in the step S3, the layout information acquirer 320 determines whether the selected type of the sample plate 90 has a staggered layout based on whether the standard layout selector 605 is selected or the staggered layout selector 606 is selected in the plate type selection screen 600 of FIG. 1 (step S5).

In a case in which the selected type of the sample plate 90 does not have a staggered layout (has the standard layout), the display controller 330 displays the standard layout information input screen 610 of FIG. 6 in the display unit (step S6). The user inputs a row hole count and a column hole count in the layout input field 611 and the layout input field 612 of the standard layout information input screen 610 using the operation unit 50 as layout information. The layout information acquirer 320 acquires the layout information input in the standard layout information input screen (step S7). The storage 390 stores the layout information acquired by the layout information acquirer 320 (step S8), and the process proceeds to the step S21.

In a case in which the type of the sample plate 90 selected in the step S5 has a staggered layout, the display controller 330 displays the staggered layout information input screen 620 of FIG. 7 in the display unit 60 (step S9). The user inputs a row hole count and a column hole count in the layout input field 611 and the layout input field 612 of the staggered layout information input screen 620 using the operation unit 50 as layout information. The layout information acquirer 320 acquires the layout information input in the staggered layout information input screen 620 (step S10).

Further, the user inputs an X deviation amount and a Y deviation amount in the deviation amount input field 621 and the deviation amount input field 622 of the staggered layout information input screen 620 using the operation unit 50. The deviation amount acquirer 360 acquires the X deviation amount and the Y deviation amount input in the staggered layout information input screen 620 (step S11). The storage 390 stores the layout information acquired by the layout information acquirer 320 and the X deviation amount and the Y deviation amount acquired by the deviation amount acquirer 360 (step S12), and the process proceeds to the step S21.

Next, the user performs teaching work. In the teaching work, the user actually inserts vials 100 into at least vial holes 91 in three corners of a sample plate 90 and fits the sample plate 90 into which the vials 100 are inserted to a sample rack 80. In this state, the user sequentially moves the sampling needle to positions above the centers of the vials 100 inserted into the vial holes 91 of the sample plate 90 using the operation unit 50 while viewing the sampling needle 10 and the sample plate 90. Further, the user sets a lowering distance of the sampling needle 10 in the lowering distance setting field 603 of the plate type selection screen 600 of FIG. 5.

In this case, the movement controller 340 moves the sampling needle 10 to a designated position by controlling the needle driving device 20 in accordance with an operation of the operation unit 50 (step S21). The position information acquirer 350 acquires an X coordinate, a Y coordinate and a Z coordinate (XYZ coordinates) of the tip of the sampling needle 10 based on an output signal of the encoder of the needle driving device 20 (step S22). Further, the position information acquirer 350 acquires the lowering distance set in the lowering distance setting field 603 of the plate type selection screen 600 (step S23). The storage 390 stores the acquired XYZ coordinates and the acquired lowering distance as the position information in association with the number of a vial hole 91 (step S24).

Next, the position information acquirer 350 determines whether a predetermined count of position information pieces are acquired (step S25). In the present example, whether the position information pieces of the vial holes 91a, 91b, 91c in the three corners of the sample plate 90 are acquired is determined.

In a case in which the predetermined count of position information pieces are not acquired, the position information acquirer 350 returns to the step S21. Thus, the steps S21 to S25 are performed in regard to a next vial hole 91. In a case in which the predetermined count of position information pieces are acquired, the teaching work ends. In the present example, when the position information pieces of the vial holes 91a, 91b, 91c in the three corners of the sample plate 90 are stored, the teaching work ends.

Next, the designation information acquirer 380 determines whether an analysis has started based on an instruction provided by the analysis control device 2 (step S26). In a case in which an analysis is not started, the designation information acquirer 380 waits.

When an analysis is started, the analysis control device 2 supplies designation information to the autosampler 1. In this case, the designation information includes the number of a vial hole 91 into which a vial 100 containing a sample to be collected is inserted. The designation information acquirer 380 acquires the designation information supplied from the analysis control device 2 (step S27). The movement controller 340 calculates a suction position in the vial hole 91 having the number designated by the designation information based on the layout information and the position information stored in the storage 390 (step S28). In a case in which the sample plate 90 is an additional plate having a staggered layout, the movement controller 340 calculates a suction position in a vial hole 91 having the number designated by the designation information based on the layout information, the position information and the deviation amounts (the X deviation amount and the Y deviation amount) stored in the storage 390.

Further, the movement controller 340 moves the sampling needle 10 to the calculated suction position by controlling the needle driving device 20 (step S29). The movement controller 340 causes the sampling needle 10 to suck the sample in the vial 100 (step S30). Next, the movement controller 340 moves the sampling needle 10 to the injection port 40 (step S31) and causes the sampling needle 10 to discharge the sample to the injection port 40 (step S32). Thereafter, the movement controller 340 moves the sampling needle 10 to a position above the sample plate 90 (step S33).

The designation information acquirer 380 determines whether an analysis has ended based on an instruction provided by the analysis control device 2 (step S34). In a case in which an analysis has not ended, the designation information acquirer 380 returns to the step S27. Thus, the steps S27 to S34 are performed based on the next designation information supplied from the analysis control device 2. In a case in which an analysis has ended in the step S34, the designation information acquirer 380 ends the work of the autosampler 1.

(6) Effects of Embodiments

With the autosampler 1 according to the present embodiment, in a case in which the user uses an additional plate, the layout input fields 611, 612 are displayed in the display unit 60. Thus, the user can input a row hole count and a column hole count of a plurality of vial holes 91 in the additional plate as layout information to the layout input fields 611, 612. Further, the position information representing the positions of the predetermined of count of vial holes 91 in the additional plate is acquired based on teaching work. During collection of a sample, the sampling needle 10 is moved to a vial hole 91 designated by the designation information based on the layout information, the position information and the designation information. Thus, the sample in the vial 100 inserted into the designated vial hole 91 can be collected by the sampling needle 10.

In this case, even in a case in which a new type of an additional plate different from a default plate is used, it is not necessary to change the configuration of a control program or the like of the autosampler 1 in accordance with the configuration of the additional plate. Therefore, it is possible to immediately collect a sample from any type of a sample plate 90 without changing the configuration of the autosampler 1.

Further, in a case in which an additional plate has a standard layout, the user can immediately use the additional plate in the autosampler 1 only by inputting a row hole count and a column hole count in the layout input fields 611, 612.

Further, in a case in which an additional plate has a staggered layout, the user can immediately use the additional plate in the autosampler 1 only by inputting a row hole count and a column hole count in the layout input fields 611, 612 and inputting an X deviation amount and a Y deviation amount in the deviation amount input fields 621, 622.

Further, in a case in which at least one of an X deviation amount and a Y deviation amount is calculated based on layout information and position information, it further saves time and labor for the user.

Further, the standard layout information input screen 610 or the staggered layout information input screen 620 is displayed sequentially by selection of the standard layout selector 605 or the staggered layout selector 606 in the plate type selection screen 600, whereby the user is prompted to input layout information. Therefore, the user can smoothly input the layout information, and an X deviation amount and a Y deviation amount as necessary in accordance with the contents of display in the display unit 60.

(7) Other Embodiments

While the operation unit 50 and the display unit 60 are provided in the autosampler 1 in the above-mentioned embodiment, at least one of the operation unit 50 and the display unit 60 may be provided separately from the autosampler 1. Further, the operation unit 4 and the display unit 5 connected to the analysis control device 2 may be used as the operation unit 50 and the display unit 60 for operating the autosampler 1. Further, a software program having a function as the calculation control device 30 may be installed in a personal computer connected to the autosampler 1, and the personal computer may also be used as the operation unit 50 and the display unit 60.

While the sample plate 90 is used as a sample container and the plurality of vial holes 91 are a plurality of containing portions in the above-mentioned embodiment, a microplate may be used as a sample container. In this case, a plurality of wells of the microplate are equivalent to a plurality of containing portions.

A suction position in a designated vial hole 91 is calculated during analysis work in the above-mentioned embodiment. However, during teaching work, suction positions in all of vial holes 91 of the sample plate 90 may be calculated, and the calculated suction positions may be stored in the storage 390 in association with the numbers of the vial holes 91.

The autosampler 1 according to the above-mentioned embodiment is not limited to a chromatograph such as a liquid chromatograph or a supercritical chromatograph, and is similarly applied to another analysis device using a sample container.

Although the user performs teaching work in the above-mentioned embodiment, in a case in which an imaging device such as a camera is provided in the autosampler 1, the teaching work may be automatically performed by an image process based on an image obtained by the imaging device.

After an additional plate is used, the type of the additional plate may be registered in the type selection region 601 of the plate type selection screen 600 as a default plate type. In this case, “FREE1” may be registered as a default plate type, for example. “FREE1” may be changed to a name representing the type of the sample plate 90. Next, in a case in which a changed name is selected in the type selection region 601, the standard layout information input screen 610 or the staggered layout information input screen 620 is not displayed in the display unit 60, and layout information stored in the storage 390 by the layout information acquirer 320 is acquired. This saves time and labor for the user in inputting the layout information again.

(8) Correspondences between Constituent Elements in Claims and Parts in Preferred Embodiments

In the following paragraphs, non-limiting examples of correspondences between various elements recited in the claims below and those described above with respect to various preferred embodiments of the present disclosure are explained. In the above-mentioned embodiment, the sample plate 90 is an example of a sample container, the vial hole 91 is an example of a containing portion, the sample rack 80 is an example of a holder, the layout input fields 611, 612 are examples of a layout input portion, the X direction is an example of a first direction, and the Y direction is an example of a second direction. Further, the row is an example of a first line, the column is an example of a second line, the X deviation amount is an example of a deviation amount in a first direction, and the Y deviation amount is an example of a deviation amount in a second direction. Further, the type selection region 601 is an example of a selecting portion, and the deviation amount input fields 621, 622 are examples of a deviation amount input portion.

(9) Aspects

It is understood by those skilled in the art that the plurality of above-mentioned illustrative embodiments are specific examples of the below-mentioned aspects.

(Item 1) An autosampler according to one aspect that collects a sample from each containing portion of a sample container, may include a holder that can selectively hold a default sample container and an additional sample container different from the default sample container, a sampling needle, a needle driver that moves the sampling needle, a layout input portion that receives input of layout information including a layout and a count of a plurality of containing portions in the additional sample container, a position information acquirer that acquires position information representing positions of a predetermined count of containing portions in an additional container held by the holder based on teaching work, a storage that stores layout information input to the layout input portion and position information acquired by the position information acquirer, a designation information acquirer that acquires designation information designating a containing portion to which the sampling needle is to be moved out of the plurality of containing portions in an additional sample container held by the holder, and a movement controller the controls the needle driver based on the stored layout information, the stored position information and the acquired designation information such that the sampling needle is moved to a containing portion designated by the designation information.

With the autosampler according to item 1, a user can use not only a default sample container but also a new type of an additional sample container. In a case in which using an additional sample container, the user can input layout information including the layout and the count of a plurality of containing portions in the additional sample container to the layout input portion. Further, the position information representing the positions of a predetermined count of containing portions in the additional sample container is acquired based on teaching work. The input layout information and the acquired position information are stored in the storage. During collection of a sample, the sampling needle is moved to a containing portion designated by designation information based on the layout information, the position information and the designation information. Thus, a sample in the designated containing portion can be collected by the sampling needle.

In this case, even in a case in which a new type of an additional sample container different from a default sample container is used, it is not necessary to change the configuration of a control program or the like of the autosampler in accordance with the configuration of the additional sample container. Therefore, it is possible to collect a sample from any type of a sample container without changing the configuration of the autosampler.

(Item 2) The autosampler according to item 1, wherein the plurality of containing portions in the additional sample container may be arranged in first and second directions that intersect with each other, and the layout information may include a count of containing portions arranged in the first direction and a count of containing portions arranged in the second direction.

With the autosampler according to item 2, the user can easily input layout information by inputting a count of containing portions in the first and second directions in the layout input portion.

(Item 3) The autosampler according to item 2, wherein the plurality of containing portions in the additional sample container may be arranged to constitute a plurality of first lines in parallel with the first direction and a plurality of second lines in parallel with the second direction, and the autosampler may further include a deviation amount acquirer that acquires at least one deviation amount of a deviation amount in the first direction between containing portions corresponding to each other in two adjacent second lines and a deviation amount in the second direction between containing portions corresponding to each other in two adjacent second lines, in a case in which containing portions corresponding to each other in two adjacent second lines of the additional sample container are deviated from each other by a certain amount in the first direction, the storage may store a deviation amount acquired by the deviation amount acquirer, and the movement controller may control the needle driver such that the sampling needle is moved to a containing portion designated by the designation information based on the stored layout information, the stored position information, the acquired designation information and the stored deviation amount.

With the autosampler according to item 3, even in a case in which a plurality of containing portions in an additional sample container have a staggered layout, a sample can be collected from any containing portion.

(Item 4) The autosampler according to item 3 may further include a display controller that displays contents of the layout input portion in a display unit, the display controller may display a deviation amount input portion for receiving input of the at least one deviation amount in the display unit, and the deviation amount acquirer may acquire a deviation amount input to the deviation amount input portion.

With the autosampler according to item 4, in a case in which an additional sample container has a staggered layout, a sample can be collected from any containing portion based on a deviation amount input by the user.

(Item 5) The autosampler according to item 3 or 4 may further include a deviation amount calculator that calculates the at least one deviation amount based on the stored position information, wherein the deviation amount acquirer may acquire a deviation amount calculated by the deviation amount calculator.

With the autosampler according to item 5, in a case in which an additional sample container has a staggered layout, because at least one deviation amount is calculated based on position information, it saves time and labor for the user in inputting a deviation amount.

(Item 6) The autosampler according to any one of items 1 to 5 may further include a display controller that displays contents of the layout input portion in a display unit, wherein the display controller may display a selector for selecting which one of the default sample container and the additional sample container is to be held by the holder in the display unit, and may display the layout input portion in the display unit in a case in which the additional sample container is selected by the selector.

With the autosampler according to item 6, in a case in which selecting an additional sample container in the selecting portion, the user can input layout information to the layout input portion. Thus, the user is prompted to input the layout information. Therefore, the user can smoothly input the layout information in accordance with the contents displayed in the display unit.

1. An autosampler that collects a sample from each containing portion of a sample container, comprising:
a holder that can selectively hold a default sample container and an additional sample container different from the default sample container;
a sampling needle;
a needle driver that moves the sampling needle;
a layout input portion that receives input of layout information including a layout and a count of a plurality of containing portions in the additional sample container in accordance with a defined input format displayed in a layout information input screen in which a layout input field for input of a hole count is provided;
a position information acquirer that acquires position information representing positions of a predetermined count of containing portions in an additional container held by the holder based on teaching work;
a storage that stores layout information input to the layout input portion and position information acquired by the position information acquirer;
a designation information acquirer that acquires designation information designating a containing portion to which the sampling needle is to be moved out of the plurality of containing portions in an additional sample container held by the holder; and
a movement controller the controls the needle driver based on the stored layout information, the stored position information and the acquired designation information such that the sampling needle is moved to a containing portion designated by the designation information.

2. The autosampler according to claim 1, wherein
the plurality of containing portions in the additional sample container are arranged in first and second directions that intersect with each other, and
the layout information includes a count of containing portions arranged in the first direction and a count of containing portions arranged in the second direction.

3. The autosampler according to claim 2, wherein
the plurality of containing portions in the additional sample container are arranged to constitute a plurality of first lines in parallel with the first direction and a plurality of second lines in parallel with the second direction, and
the autosampler further includes a deviation amount acquirer that acquires at least one deviation amount of a deviation amount in the first direction between containing portions corresponding to each other in two adjacent second lines and a deviation amount in the second direction between containing portions corresponding to each other in two adjacent second lines, in a case in which containing portions corresponding to each other in two adjacent second lines of the additional sample container are deviated from each other by a certain amount in the first direction,
the storage stores a deviation amount acquired by the deviation amount acquirer, and
the movement controller controls the needle driver such that the sampling needle is moved to a containing portion designated by the designation information based on the stored layout information, the stored position information, the acquired designation information and the stored deviation amount.

4. The autosampler according to claim 3, further comprising a display controller that displays contents of the layout input portion in a display unit,
the display controller displays a deviation amount input portion for receiving input of the at least one deviation amount in the display unit, and
the deviation amount acquirer acquires a deviation amount input to the deviation amount input portion.

5. The autosampler according to claim 3, further comprising a deviation amount calculator that calculates the at least one deviation amount based on the stored position information, wherein
the deviation amount acquirer acquires a deviation amount calculated by the deviation amount calculator.

6. The autosampler according to claim 1, further comprising a display controller that displays contents of the layout input portion in a display unit, wherein
the display controller displays a selector for selecting which one of the default sample container and the additional sample container is to be held by the holder in the display unit, and displays the layout input portion in the display unit in a case in which the additional sample container is selected by the selector.
